(19) United States
(12) Patent Application Publication
(10) Pub. No.: US 2012/0079728 A1
(43) Pub. Date: Apr. 5, 2012

(54) SAW BLADE, KNIFE AND SAW

(75) Inventor: Henrik Sjöholm, Bollnas (SE)

(73) Assignee: KAPMAN AB, Sandviken (SE)

(21) Appl. No.: 13/378,374

(22) PCT Filed: Jul. 2, 2010
(86) PCT No.: PCT/SE2010/050768

§ 371 Date: Dec. 15, 2011

(30) Foreign Application Priority Data
Jul. 2, 2009 (SE) 0950520-7

(51) Int. Cl. B23D 61/12; B26B 9/02; B26B 3/00; B26B 5/00; B26D 7/00; B23D 51/00

(52) U.S. Cl. 30/517; 83/835; 83/851; 30/165

(57) ABSTRACT

The present invention relates to a saw blade with teeth, at least one of said teeth being set and said teeth have at least one continuously continuous sharp edge that is common to the teeth and, in a main plane of extension of the saw blade and prior to setting, has either a pure sinusoidal shape or a modified sinusoidal shape. The present invention also relates to a knife and a saw.

The present invention relates to a saw blade having teeth. The present invention also relates to a knife and a saw.

### PRIOR ART

The American patent application with publication number US, A1, 2005/0139049 discloses systems and methods to cut/saw corrugated material of multi-layer type. There is found a band saw blade having a wavelike edge that is chamfered and set. The blade is considered to decrease the generation of dust during sawing in comparison with what is the case when sawing using a circular sawing machine. However, the generation of dust is still too great.

### SUMMARY OF THE INVENTION

A first object of the present invention is to provide a saw blade that causes minimal dust generation during sawing of, for instance, insulating material. A second object of the present invention is to provide a knife that is equipped with a saw blade according to the invention. A third object of the present invention is to provide a saw that is equipped with a saw blade according to the invention. Thus, the invention embraces a saw blade having teeth, at least one of said teeth being set and said teeth having at least one continuously continuous sharp edge that is common to the teeth and, in a main plane of extension of the saw blade and prior to setting, has either a pure sinusoidal shape or a modified sinusoidal shape.

The modified sinusoidal shape may entirely or partly have a different amplitude than the pure sinusoidal shape. The modified sinusoidal shape may entirely or partly have a different frequency than the pure sinusoidal shape. The modified sinusoidal shape may entirely or partly have a different wavelength than the pure sinusoidal shape. The modified sinusoidal shape may entirely or partly have a different frequency and/or a different wavelength than the pure sinusoidal shape. The modified sinusoidal shape may entirely or partly have a different amplitude and/or a different frequency and/or a different wavelength than the pure sinusoidal shape. The modified sinusoidal shape may be continuous. The modified sinusoidal shape may be non-continuous.

At least one of said teeth may have a ridge on which said edge is more extended in the main direction of extension of the edge than what corresponds to a pure sinusoidal shape of the edge. At least two of said teeth may have an intermediate valley in which said edge is more extended in the main direction of extension of the edge than what corresponds to a pure sinusoidal shape of the edge. At least one of said teeth may have a ridge on which said edge is more extended in the main direction of extension of the edge than what corresponds to a pure sinusoidal shape of the edge at the same time as at least two of said teeth may have an intermediate valley in which said edge is more extended in the main direction of extension of the edge than what corresponds to a pure sinusoidal shape of the edge.

At least one of said teeth may be set in one direction and at least one of said teeth may be set in the other direction. Every second tooth of said teeth may be set in one direction and every second tooth of said teeth may be set in the is other direction. In a group of three sequencing teeth of said teeth, one tooth may be set in one direction, one tooth be set in the other direction and one tooth be unset. In a group of four sequencing teeth of said teeth, one tooth may be set in one direction, one tooth be set in the other direction and two teeth be unset. In a group of four sequencing teeth of said teeth, a first tooth may be unset, a second tooth be set in one direction, a third tooth be unset and a fourth tooth be set in the other direction.

Thus, the invention also embraces a knife comprising at least one saw blade according to the above.

Thus, the invention also embraces a saw comprising at least one saw blade according to the above. The saw may comprise at least one handle for handsawing. Said at least one saw blade may be detachable from said at least one handle. The saw may comprise equipment for machine sawing.

### LIST OF FIGURES

FIG. 1a shows, in a schematic view from above, a saw blade according to the invention, setting not being shown.

FIG. 1b shows, in a side view, the saw blade according to FIG. 1a supplemented with a partial enlargement and setting being shown.

FIG. 1c shows, in a front view, a variant of the saw blade according to FIG. 1a supplemented with a partial enlargement and setting being shown.

FIG. 2 shows, in a side view, an alternative saw blade according to the invention and supplemented with a partial enlargement, occurring setting not being shown.

### DESCRIPTION OF EMBODIMENTS

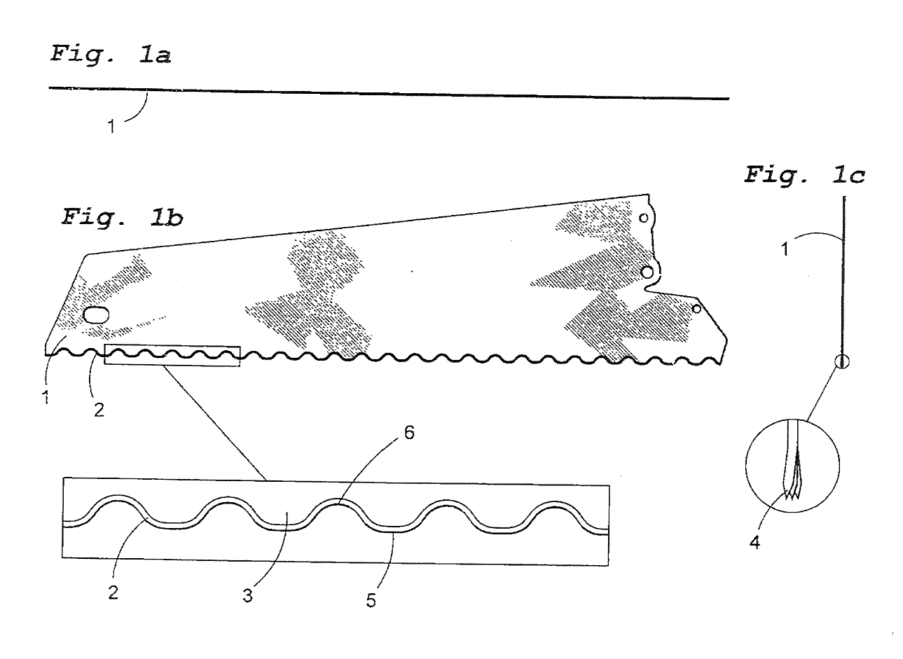

A first embodiment of a saw blade according to the invention is seen in the FIGS. 1a and 1b. A saw blade 1 has a wave-shaped edge 2 with teeth 3. The edge 2 is chamfered to a sharp cutting edge 4 that runs in the entire length of the saw blade 1.

The edge 2 has, in a main plane of extension of the saw blade 1 and prior to setting of the teeth 3, a modified sinusoidal shape. The modification of the sinusoidal shape is such that the teeth 3 have ridges 5 on which said edge 2 is more extended in the main direction of extension of the edge than what corresponds to a pure sinusoidal shape of the edge at the same time as said teeth 3 have intermediate valleys 6 in which said edge 2 is more extended in the main direction of extension of the edge than what corresponds to a pure sinusoidal shape of the edge. From the partial enlargement in FIG. 1b, it is seen that the edge 2 is more extended in the main direction of extension of the edge in the crest of each ridge 5 than the edge 2 is in the bottom of each valley 6. In the transition between each ridge 5 and valley 6, the edge 2 has a local direction of extension that is angled approx. 45° to the main direction of extension of the edge.

It should be observed that a second embodiment instead may have an edge 2 that is more extended in the main direction of extension of the edge in the bottom of each valley 6 than the edge 2 is in the crest of each ridge 5. A third embodiment may have an edge 2 that is as extended in the main direction of extension of the edge in the bottom of each valley 6 as in the crest of each ridge 5. A fourth embodiment may have an edge 2 that is not extended, i.e., the edge has a pure sinusoidal shape.

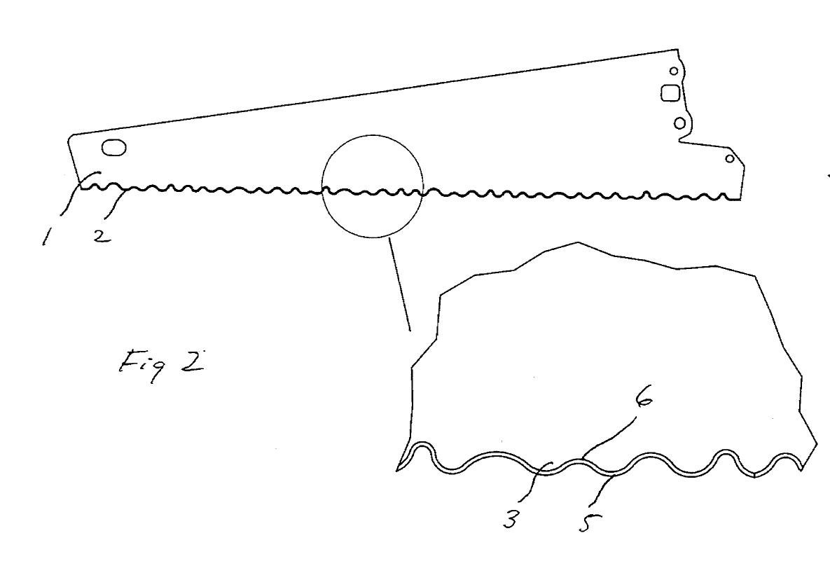

An additional embodiment of a saw blade according to the invention is seen in FIG. 2. Here, the edge 2 has, in a main plane of extension of the saw blade 1 and prior to setting of the teeth 3, a modified sinusoidal shape for which the amplitude as well as the frequency and wavelength vary in a non-continuous way. Said parameters may also vary individually or in any combination, and in all cases continuously as well as non-continuously. If several parameters vary simultaneously, for instance, amplitude and frequency, both variations may be continuous or non-continuous or a first variation (no matter which) may be continuous while a second variation (no matter which) is non-continuous.

It should also be observed that, for each one of the mentioned embodiments, the edge 2 in the transition between each ridge 5 and valley 6 may have a local direction of extension that is angled approx. 0-90°, preferably approx. 10-80° and most preferably approx. 45° to the main direction of extension of the edge.

The teeth 3 are, for each one of the mentioned embodiments, alternately set, every second to the left and every second to the right, i.e., every second up from the plane of the paper and every second down under the plane of the paper in the partial enlargement in FIG. 1b. Of course, it is possible to conceive a number of other setting sequences, for instance, unset, set to the left, unset, set to the right, etc. recurrently. Observe that FIG. 1c shows a variant having at least one tooth unset.

The saw blade 1 having the wave-shaped edge 2 saws insulating material such as “styrofoam” and mineral wool efficiently and causes a minimum of sawdust. The setting makes it easier for the blade to create sufficient free space during sawing so that the blade does not get caught. The fact that the edge 2 lacks sudden sharp local direction changes of the extension thereof also makes it easier for the blade to move freely during sawing and minimizes chip formation.

A knife according to the invention is provided with a blade according to the invention, and the blade may be fixedly mounted in a knife handle from the manufacturer but may also be detachably mounted in the handle.

A saw according to the invention is provided with a blade according to the invention, and the blade may be fixedly mounted in a saw handle from the manufacturer but may also be detachably mounted in the handle. The saw may comprise equipment for machine sawing.

The wave-shaped edge 2 may also be present on saw blades for machine sawing, for instance, band saw blades, circular saw blades and compass saw blades.

The invention is not limited to the embodiments shown herein, but may be varied within the scope of the subsequent claims.

1. Saw blade with teeth, wherein at least one of said teeth is set and that said teeth have at least one continuously continuous sharp edge that is common to the teeth and, in a main plane of extension of the saw blade and prior to setting, has either a pure sinusoidal shape or a modified sinusoidal shape.

2. Saw blade according to claim 1, wherein the modified sinusoidal shape entirely or partly has a different amplitude than the pure sinusoidal shape.

3. Saw blade according to claim 1, wherein the modified sinusoidal shape entirely or partly has a different frequency than the pure sinusoidal shape.

4. Saw blade according to claim 1, wherein the modified sinusoidal shape entirely or partly has a different wavelength than the pure sinusoidal shape.

5. Saw blade according to claim 1, wherein the modified sinusoidal shape entirely or partly has a different frequency and/or a different wavelength than the pure sinusoidal shape.

6. Saw blade according to claim 1, wherein the modified sinusoidal shape entirely or partly has a different amplitude and/or a different frequency and/or a different wavelength than the pure sinusoidal shape.

7. Saw blade according to claim 1, wherein the modified sinusoidal shape is continuous.

8. Saw blade according to claim 1, wherein the modified sinusoidal shape is non-continuous.

9. Saw blade according to claim 1, wherein at least one of said teeth has a ridge on which said edge is more extended in the main direction of extension of the edge than what corresponds to a pure sinusoidal shape of the edge.

10. Saw blade according to claim 1, wherein at least two of said teeth have an intermediate valley in which said edge is more extended in the main direction of extension of the edge than what corresponds to a pure sinusoidal shape of the edge.

11. Saw blade according to claim 1, wherein at least one of said teeth has a ridge on which said edge is more extended in the main direction of extension of the edge than what corresponds to a pure sinusoidal shape of the edge at the same time as at least two of said teeth have an intermediate valley in which said edge is more extended in the main direction of extension of the edge than what corresponds to a pure sinusoidal shape of the edge.

12. Saw blade according to claim 1, wherein at least one of said teeth is set in one direction and at least one of said teeth is set in the other direction.

13. Saw blade according to claim 1, wherein every second tooth of said teeth is set in one direction and every second tooth of said teeth is set in the other direction.

14. Saw blade according to claim 1, wherein, in a group of three sequencing teeth of said teeth, one tooth is set in one direction, one tooth is set in the other direction and one tooth is unset.

15. Saw blade according to claim 1, wherein, in a group of four sequencing teeth of said teeth, one tooth is set in one direction, one tooth is set in the other direction and two teeth are unset.

16. Saw blade according to claim 15, wherein, in a group of four sequencing teeth of said teeth, a first tooth is unset, a second tooth is set in one direction, a third tooth is unset and a fourth tooth is set in the other direction.

17. Knife comprising at least one saw blade according to claim 1.

18. Saw comprising at least one saw blade according to claim 1.

19. Saw according to claim 18, which comprises at least one handle for handsawing.

20. Saw according to claim 19, wherein said at least one saw blade is detachable from said at least one handle.

21. Saw according to claim 18, which comprises equipment for machine sawing.
